(19) United States
(12) Patent Application Publication
(10) Pub. No.: US 2005/0060181 A1
(43) Pub. Date: Mar. 17, 2005

(54) Apparatus and system for providing a paperless illustration environment

(76) Inventor: Mary Quinn Jaensch, Sunderland, MD (US)

Correspondence Address: CAHN & SAMUELS LLP, 2000 P STREET NW, SUITE 200, WASHINGTON, DC, 20036, US

(21) Appl. No.: 10/967,185

(22) Filed: Oct. 19, 2004

Related U.S. Application Data
(63) Continuation-in-part of application No. 10/682,779, filed on Oct. 10, 2003.
(60) Provisional application No. 60/417,175, filed on Oct. 10, 2002.

(51) Int. Cl. G06F 17/60

(52) U.S. Cl. 705/1

(57) ABSTRACT

A system, method, computer program product, and computer data signal for facilitating collaboration between users regarding graphical illustrations or images over a computer network. The invention preferably allows users to more easily conduct all aspects of the drafting process in a secure environment while realizing substantial time and actual cost savings, improving productivity, and allowing draftspersons and their customers, for example, to work from different locations. After registering with the system of the invention, a user preferably places an order for drawings using the virtual order desk. After a draftsperson creates the digital drawings and posts them on a website, for example, the user may download the drawings and/or enter the virtual drawing board to “markup” the digital drawings or place notes to the draftsperson to assist with revision of the drawings. The user may also communicate simultaneously with other users in the on-line virtual conference room. Finally, the user may access all of the user's drawings in a central drawing file repository.

This application is a continuation-in-part application of U.S. patent application Ser. No. 10/682,779, filed on Oct. 10, 2003, which claims the benefit of U.S. provisional application Ser. No. 60/417,175, filed on Oct. 10, 2002. Each of the foregoing applications is incorporated herein by reference.

### I. FIELD OF THE INVENTION

The present invention relates generally to illustrations, and more particularly to facilitating collaboration between draftspersons and their clients regarding illustrations or images.

### II. BACKGROUND OF THE INVENTION

Drawings, images, and other graphical representations are an integral part of the day to day operations of a variety of industries. Engineers, scientists, architects, technicians, law enforcement officials, doctors, and attorneys all use drawings to conduct their routine job activities. For instance, civil engineers often require blueprint drawings or illustrations of a structure before they begin work to create the structure. As another example, the U.S. patent system requires patent applicants to submit drawings as a part of their patent applications. Thus, the inventor will sometimes create a freehand sketch of his invention.

Informal drawings such as sketches are invaluable in that they allow the creator to capture an idea or vision in a concrete format. A professional draftsperson often must be employed, however, to assist in creating a more formal version of the drawing to achieve a more accurate presentation of the represented material. During this process of achieving a more accurate presentation of the represented materials, several significant problems are presented.

For example, a customer of a draftsperson often contacts the draftsperson via telephone and is possibly subjected to being placed on hold before placing an order for drawings. In addition, the customer often must send copies of the original drawings to the draftsperson to use as a guide. Thus, the customer must often gain access to a facsimile machine to transmit copies of the original drawings to the draftsperson. As a result, the customer may lose valuable time and effort. Further, the individual submitting an order for drawings may be part of a team. In such a situation, other members of the team may be interested in learning the status of an order placed, for example, learning whether the drawings for an order have been completed. The draftsperson sometimes will provide the individual placing the drawing order with identifying information regarding the drawing. This information, however, is often not provided to other team members who may be located in different geographical locations, for example. Thus, a group of other team members may not be able to gain access to the particular drawing order.

In addition to the aforementioned problems, problems related to the back-and-forth procedure inherent in the current drafting process are often presented. For example, as the more informal drawings are often rough sketches, they are often not very clear. For example, an inventor may have created a simple drawing in pencil, and the lines may have been blurred. This sometimes results in the inventor having to resend revised versions of the original drawings or having to telephone the draftsperson in an attempt to clarify the unclear portion of the drawing. Further, even in the best of situations, in an attempt to obtain the most clear, accurate, and precise more formal illustrations, the draftsperson and the client will engage in a “back-and-forth” process, as the material represented by the drawings may be difficult to capture and illustrate. For example, an orientation angle of a device in the original drawing may be unclear to the professional draftsperson even after viewing the original drawing. In such a situation, the draftsperson uses his experience and drafting skills to determine the best orientation angle for the device and captures it in the more formal drawing accordingly.

After receiving the more formal drawing from the draftsperson, the inventor may discover that the draftsperson's drawing does not correspond to his or her more informal drawing as accurately and precisely as it should (for example, the angle of orientation is incorrect in the draftsperson's version of the drawing). This sometimes results in the draftsperson having to substantially modify the drawing after spending a considerable amount of time on the telephone with the inventor in an attempt to better understand what the inventor would like accomplished. Thus, valuable time loss and frustration may occur as a result of this problem.

In addition, in some instances, an inventor may not know what orientation angle works best for depicting a particular device clearly. In such a situation, the draftsperson may be required to blindly experiment with the angle of orientation, for example, of material in the more formal drawing.

Regardless of whether the inventor's version of the drawings are unclear to the draftsperson or the inventor simply is uncertain as to how a particular feature or aspect of a drawing should be captured to best illustrate the represented device or material, the formal drafting process may not proceed efficiently, as the back-and-forth process wastes valuable resources such as money and time. Thus, efficiency problems are often experienced in the formal drafting process.

In addition, the individual requesting the drawings from the draftsperson often would like to gain feedback from other individuals on his team (for example, patent attorneys at a law firm and in-house attorneys) on the accuracy of the more formal drawings submitted by the draftsperson. The team members, however, are often located in different geographical areas, and valuable time and money is often wasted in faxing the drawings to the various team members.

Further, drawing versions are sometimes created for each particular stage of the product represented by the drawings or illustrations. For example, an inventor may create one set of illustrations representing his or her invention in its early stages, another set of illustrations representing his or her invention in its intermediate stage, and yet another set of illustrations representing his or her invention in its advanced stage. As the number of drawing versions increases, the likelihood of complexity of archiving the drawings may increase. As a result, a problem may be experienced in which drawing files are lost or out of order. Or a problem may be experienced in which the drawings for one matter are “mixed-in” with the drawings from another matter.

Therefore, in light of the foregoing, what is needed is a system, method, computer program product, and computer data signal for providing a paperless illustration environment.

Accordingly, there is a need for a paperless drawing system and method that overcomes the aforementioned problems.

### III. SUMMARY OF THE INVENTION

The present invention preferably allows users to more easily conduct all aspects of the drafting process in a secure environment while realizing substantial time and actual cost savings, improving productivity, and allowing draftspersons and other users of the system (for example, customers of the draftsperson) to work from different geographical locations.

The invention offers a secure environment in which users preferably register to access the system. After registration, the user is preferably provided with on-line access to a virtual order desk to allow the user to order drawings and track drawing orders. The user may place an order for digital drawings using the virtual order desk which allows the user to set preferences regarding the digital drawings and on-line invoices for the drafting work. It should be noted that the term “drawing” as used herein preferably includes a photograph, a sketch, an illustration, a blueprint, a computer-aided drawing (CAD), and/or any digital drawing or graphical representation. In at least one embodiment of the invention, the user may set preferences as to whether the user would like to grant other users access to the order placed by the user. After registration, the user may login to the system and download digital drawing files prepared by a draftsperson. In at least one embodiment, the user preferably downloads the digital drawing files in a variety of different file type formats. At least one embodiment of the invention allows the user to revise or perform “markups” to the drawing file on a virtual drawing board. Using the virtual drawing board, the user may enter messages or notes to the draftsperson, cross out parts of the particular drawing, and indicate that parts of the drawing should be altered or changed.

In keeping with a particularly advantageous feature of the invention, a virtual conference room is provided. A plurality of users (for example, at least one draftsperson and/or other users of the system such as a team of individuals representing the draftsperson's customers) may engage in communication while simultaneously viewing the virtual drawing board to discuss a feature that is particularly difficult to capture. In at least one embodiment, such communication occurs in real-time or near real-time. In at least one embodiment, the communication occurs in a multi-media environment.

In keeping with another particularly advantageous feature of the invention, a drawing file repository is provided. The drawing file repository preferably includes access to a central storage location at which all drawings for a customer may be stored.

In at least one embodiment, the present invention is a system for facilitating collaboration between draftspersons and their clients regarding graphical illustrations or images over a computer network. The invention preferably includes a first module for receiving an order for preparation of drawings, a second module for allowing review, revision, downloading and approval of the drawings, a third module for allowing interactive communications regarding the drawings to occur wherein the communications occur between a first individual and a second individual, and at least one server computer accessible via the computer network by at least one client computer. The server computer preferably executes the first, second, and third modules (for example, computer program modules) to allow a user of the client computer to interact with the system. In at least one embodiment, the server further includes a fourth module to allow a user to register with the system of the invention.

An objective of the present invention is to eliminate or minimize the use of drawings produced on paper.

An objective of the present invention is to eliminate or minimize conversion procedures in the drafting process.

An objective of the present invention is to facilitate tracking of multiple versions of drawings.

An advantage of the present invention is that it enables a draftsperson to transmit drawings to a customer quickly and inexpensively.

An advantage of the present invention is that it facilitates rule compliance with The United States Patent and Trademark Office.

An advantage of the present invention is that it offers a globally accessible system which allows flexibility in work locations.

### IV. BRIEF DESCRIPTION OF THE DRAWINGS

The use of cross-hatching or shading within these drawings should not be interpreted as a limitation on the potential materials used for construction. Like reference numerals in the figures represent and refer to the same element or function.

FIG. 1A illustrates an exemplary client-server computing environment 100 in which the present invention may be employed including a server computing site and a client computing site according to at least one embodiment of the invention.

FIG. 1B is a block diagram depicting an exemplary computer system capable of executing the computer program modules of the automated system of the invention according to at least one embodiment of the present invention.

FIG. 2 is an exemplary web server page illustrating hypertext links to three aspects of the system according to at least one embodiment of the invention.

FIG. 3 is an exemplary user registration web page according to at least one embodiment of the invention

FIG. 4 is an exemplary registration continuation message according to at least one embodiment of the present invention.

FIG. 5 is an exemplary registration confirmation message according to at least one embodiment of the present invention.

FIG. 6 is an exemplary user login page according to at least one embodiment of the present invention.

FIG. 7 is an exemplary electronic user profile form according to at least one embodiment of the present invention.

FIG. 8 is an exemplary electronic user profile edit form according to at least one embodiment of the present invention.

FIG. 9A is an exemplary electronic virtual order desk form including information data fields according to at least one embodiment of the invention.

FIG. 9B is an exemplary electronic virtual order desk form including shared workspace and preferences for order sections according to at least one embodiment of the invention.

FIG. 10 is an exemplary electronic virtual order confirmation message according to at least one embodiment of the invention.

FIG. 11 is an exemplary electronic drawing upload form utilized by a system administrator according to at least one embodiment of the invention.

FIG. 12 is an exemplary electronic order search form accessible by a system administrator according to at least one embodiment of the invention.

FIG. 13 is an exemplary electronic delete order form accessible by a system administrator according to at least one embodiment of the invention.

FIG. 14 is an exemplary electronic drawing information chart according to at least one embodiment of the invention.

FIG. 15 is an exemplary virtual drawing board access chart 1500 accessible by a system administrator according to at least one embodiment of the invention.

FIG. 16 is an exemplary electronic virtual drawing board according to at least one embodiment of the invention.

FIG. 17 illustrates a virtual conference room according to at least one embodiment of the invention.

FIG. 18 illustrates an exemplary drawing file repository according to at least one embodiment of the invention.

FIG. 19 illustrates an exemplary search screen for the drawing file repository according to at least one embodiment of the invention.

### V. DETAILED DESCRIPTION OF THE DRAWINGS

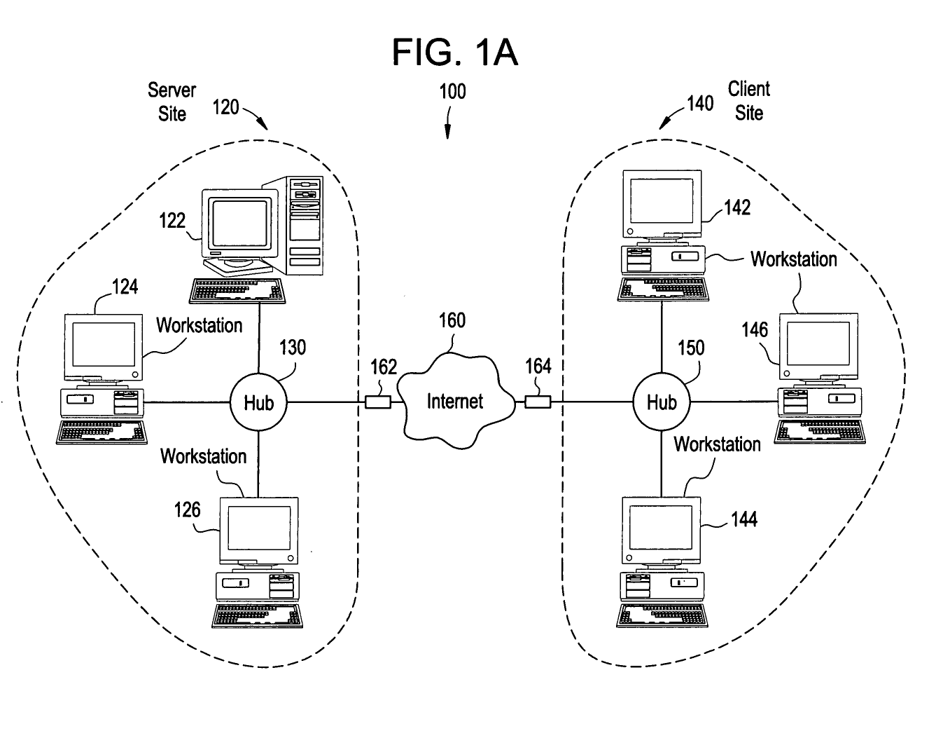

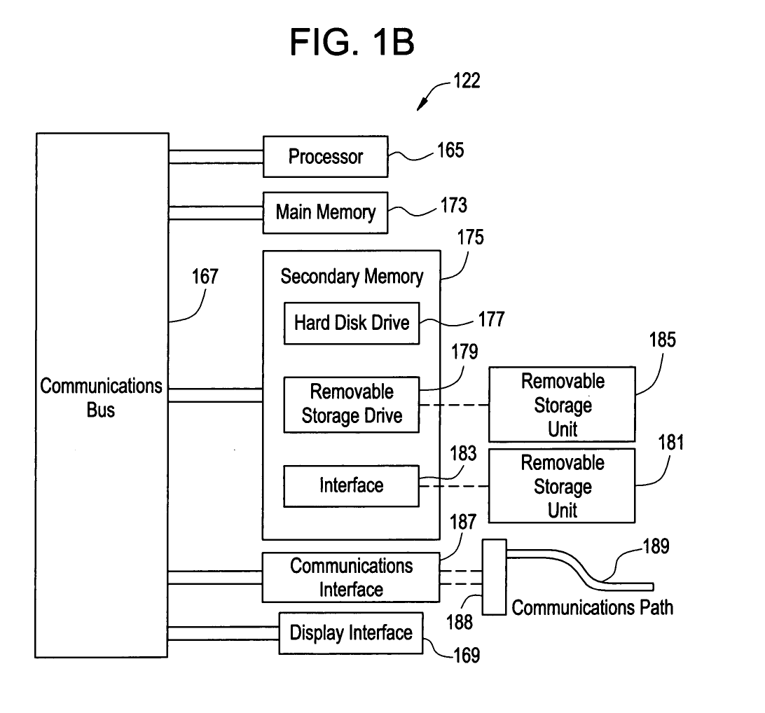

FIG. 1A illustrates an exemplary client-server computing environment 100 in which the present invention is preferably utilized. Although FIG. 1 illustrates a client-server computing environment 100, it should be noted that the illustration is presented for purposes of illustration. After being presented with the disclosure herein, those skilled in the relevant art will realize that a variety of other environments may be presented. For example, the present invention may also be utilized in a token ring computer network, as would be known to those of ordinary skill in the art after being presented with the disclosure herein. The computing environment 100 preferably includes a server computing site 120 (for example, a server computing network) and a client computing site 140 (for example, a client computing network).

The client computing site 140 is preferably electronically coupled to the server computing site 120 through the Internet 160 via the bridges or routers 162 and 164. In at least one embodiment of the invention, however, the bridges or routers 162 and 164 are not present. In such an embodiment, the hubs 130 and 150 are preferably directly electronically coupled to the Internet. In such a situation, the hubs 130 and 150 are preferably replaced by bridges or any other routing mechanism, as would be known to one skilled in the relevant art(s). Further, it should be noted, however, that in some embodiments of the present invention, the server computing site 120 is preferably electronically coupled to the client computing site 140 directly via a main bridge (not shown). In such a configuration, the Internet 160 is replaced by the main bridge, and the system preferably operates on a private network (for example, an intranet), as opposed to the Internet. Regardless of the communication configuration, however, users at the server computing site 120 preferably communicate with users at the client computing site 140. For example, in at least one embodiment, a virtual conference may be held between users at the two site.

As depicted in FIG. 1A, the server computing site 120 preferably includes computer web server 122 and workstations 124 and 126, for example. At least one individual such as a draftsperson is preferably a user of one of the workstations 124 and 126. The workstations 124 and 126 preferably communicate through the hub 130 according to a communications (for example, telecommunications) method well known to those of ordinary skill in the relevant art. For example, a draftsperson using workstation 124 on the server site 120 may email another draftsperson using workstation 126 to notify the draftsperson of a question or advice sought regarding the drawings of a particular customer.

In at least one embodiment, the computer web server 122 includes a plurality of modules such as computer program modules for program execution. Execution of the program modules allows a user at a workstation at the client computing site 140 to access the system of the present invention, as will be described further herein below.

The client computer site 140 preferably includes workstations 142, 144, and 146. At least one individual such as a customer of a draftsperson is preferably a user of one of the workstations 142, 144, and 146. The workstations 142, 144, and 146 preferably communicate electronically with each other through the hub 150 according to a telecommunications method well known to those of ordinary skill in the art. For example, a client using workstation 142 on the client site 140 may confer (for example, via email, or via a virtual conference) with another member of his or her team regarding the results of an electronic formal drawing submitted by a draftsperson. The client site 120 is also preferably the location at which the client registers to use the system of the present invention, as will be described in detail further below.

Referring to FIG. 1B, an exemplary computer web server 122 for executing the computer program modules of the present invention is shown. It should be noted that the term computer or workstation is used herein to refer to any computer system with or without associated input and output devices. For example, a workstation or computer of the present invention may be a desktop computer, a laptop computer, palmtop computer, or personal digital assistant (PDA) or the like, with their associated input (for example, a keyboard) and output (for example, a computer display) devices. Exemplary workstations or computers used to implement the invention include, but are not limited to, Apple®, Sun Microsystems®, IBM®, or IBM®-compatible personal computers, and Dell® Computers. Exemplary hardware for implementing the present invention includes an IBM®-compatible computer system having recommended specifications of a Pentium® 90 MHz microprocessor, at least 64 MB RAM, a PCMCIA Card Reader, and a computer display monitor. Recommended operating systems include Microsoft® Windows® 95, 97, 98, 2000, NT, XP, and the Macintosh operating system.

The computer web server 122 includes one or more processors, such as processor 165 (for example, a microprocessor). The processor 165 is connected to a communications bus 167.

The processor 165 of the computer web server 122 preferably executes the computer program modules of the present invention. The processor 165 may be housed in one of the computer systems described above. It should also be noted that various software embodiments are described in terms of the exemplary computer web server 122 depicted in FIG. 1B. After reading the description herein, it will become apparent to a person skilled in the relevant art how to implement the invention using other computer systems and/or computer architectures.

Computer web server 122 may include a display interface 169 that forwards graphics, text, and other data from the communications bus 167 for display on a display device (not shown) coupled to the system. Computer web server 122 also includes a main memory 173, preferably random access memory (RAM), and may also include a secondary memory 175. The secondary memory 175 may include, for example, a hard disk drive 177 and/or a removable storage drive 179, representing a floppy disk drive, a magnetic tape drive, or an optical disk drive, etcetera. The removable storage drive 179 reads from and/or writes to a removable storage unit 181 in a manner well known to those skilled in the relevant art. Removable storage unit 181 represents a floppy drive, magnetic tape, memory stick, or optical disk. As will be appreciated by those skilled in the art, the removable storage unit 181 includes a computer usable storage medium having stored therein computer software and/or data.

In alternative embodiments, secondary memory 175 may include other similar means for allowing the computer program modules of the present invention to be loaded into the components of the computer web server 122. Such means may include, for example, the removable storage unit 181 and an interface 183. Examples of such may include a program cartridge and cartridge interface (such as that found in video game devices), a removable memory chip (such as an EPROM or PROM) and associated socket, and other removable storage units 185 which allow software and data to be transferred from the removable storage unit 181 to the workstation 122.

The computer web server 122 may also include a communications interface 187. The communications interface 187 allows software and data to be transferred between the computer web server 122 and external devices. Examples of the communications interface 187 include but are not limited to, a modem, a network interface, an Ethernet card, a communications port, and a PCMCIA slot and card. Software and data transferred via the communications interface 187 are preferably in the form of signals 188, which may be electronic, electromagnetic, optical, or other signals capable of being received by the communications interface 187. The signals 188 are preferably provided to the communications interface 187 via a communications path (for example, a channel) 189. The path 189 carries signals 188 and may be implemented using wire, cable, fiber optics, a phone line, a cellular phone link, an RF link and other communications channels.

The term computer program product as used herein generally refers to media such as a computer program medium or a computer usable medium. Removable storage drive 179, a hard disk installed in hard disk drive 177, a computer diskette, a cd, and signals are examples of computer program media and serve as means for providing software to the workstation 122. In other words, a computer program product is a product on which a module (for example, a computer program module) of the present invention may be stored for execution.

In accordance with an embodiment of the invention, the computer program modules of the present invention may be stored in main memory 173 and/or secondary memory 175. The computer program modules may also be received via communications interface 187. When executed, the computer program modules cause the computer web server 122 to perform the features of the present invention as discussed herein. More specifically, the computer program modules of the present invention, when executed, enable the processor 165 to perform the features of the present invention. Accordingly, such computer program modules represent controllers of the computer web server 122.

In at least one embodiment, the computer program modules of the present invention include computer readable instructions. One skilled in the art will recognize that the computer readable instructions included in the computer program modules of the present invention can be in the form of any viable computer programming language. For example, a high-level programming language such as C, C++, Ada, LISP, Cobol, Fortran, or Beginners All-Purpose Symbolic Instruction Code (BASIC) can be utilized to program the program modules of the present invention. It should be noted that the term “module,” “program module,” or “computer program module” is used herein to refer to a set of computer instructions for accomplishing a task. Thus, as used herein, a program module may or may not be embodied in the same electronic file or medium.

In addition to being implemented in software, the present invention may be implemented primarily in hardware using, for example, hardware components such as application specific integrated circuits (ASICs). Implementation of a hardware state machine so as to perform the functions described herein will be apparent to persons skilled in the art after being provided with the description herein.

It should be noted that an exemplary workstation (for example, 142) at the client computing site 140 may also be illustrated by the depiction in FIG. 1B. In such a situation, the workstation preferably includes communications hardware and/or software to allow it to access the computer web server 122 at the server computing site 120. For instance, in at least one embodiment of the present invention, web browser software such as Internet Explorer® or Netscape Navigator® is executed by a workstation at the client computing site 140.

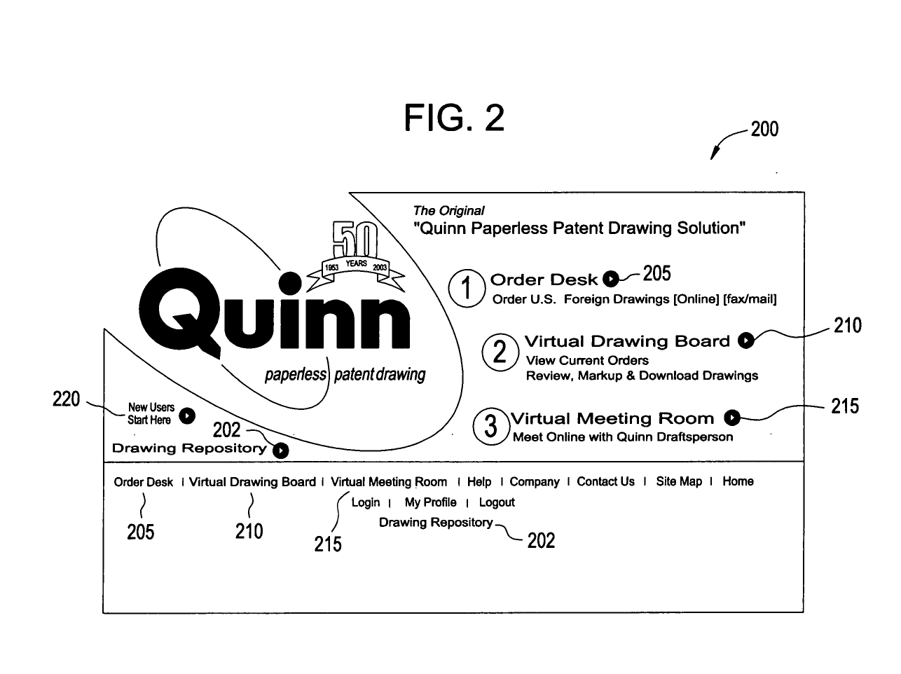

FIG. 2 illustrates an exemplary home page 200 of the system of the present invention. For instance, in at least one embodiment, the exemplary home page 200 is presented by the computer web server 122 (FIG. 1) and accessed by at least one user at one of the workstations at the client computing site 140, for example. For instance, a user residing at the workstation 142 at the client computing site 140 preferably opens a computer browser such as Microsoft Internet Explorer® or Netscape Navigator® and types in the web site address of a provider of the present invention (for example, http://www.quinnpatent.com). In at least one embodiment, the exemplary home page 200 of the present invention preferably includes at least one of a hypertext link to a virtual order desk 205, a virtual drawing board 210, and a virtual meeting room 215. In at least one embodiment, the home page 200 preferably further includes a drawing repository hypertext link 202. To activate a particular one of the features represented by one of the hypertext links, a client using one of the workstations at the client computing site 140, for example, clicks on the hypertext link with his or her computer mouse, for example, thereby causing a particular computer program module to execute to present the respective feature of the present invention.

Before the client may access a particular feature for the first time, however, the client preferably must first register to use the system by clicking on “new user” hypertext link 220.

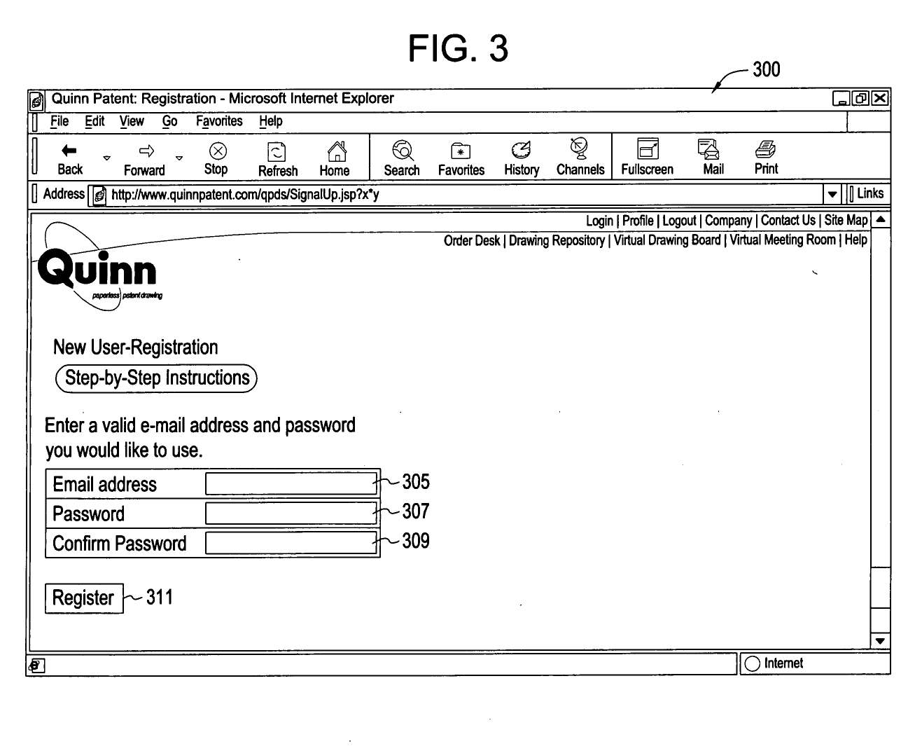

Upon clicking on the new user hypertext link, a computer program module on the computer web server 122 at the server site 120 is executed, thereby presenting the user with the “new user registration page” 300, as illustrated in FIG. 3. The new user registration page 300 preferably includes an email address data field 305, a password data field 307, a confirm password data field 309, and a register submittal button 311.

The email address data field 305 preferably accepts a valid email address from the user (for example, joeclient@clientsite.com). The email address is preferably required to allow a system administrator, for example, at the server site 120 to email the selected password to the user. In at least one embodiment, a user name data field is provided for further identification.

The password data field 307 preferably accepts a valid password to provide a secure environment for the present invention, as would be known to those of ordinary skill in the relevant art after being presented with the disclosure herein. The confirm password data field 309 allows the user at the client computing site to confirm the user's password. After the user confirms the entered password by re-keying the password in the confirm password data field 309, the user preferably clicks on the register submittal button 311 to submit the registration information (for example, the email address and desired password).

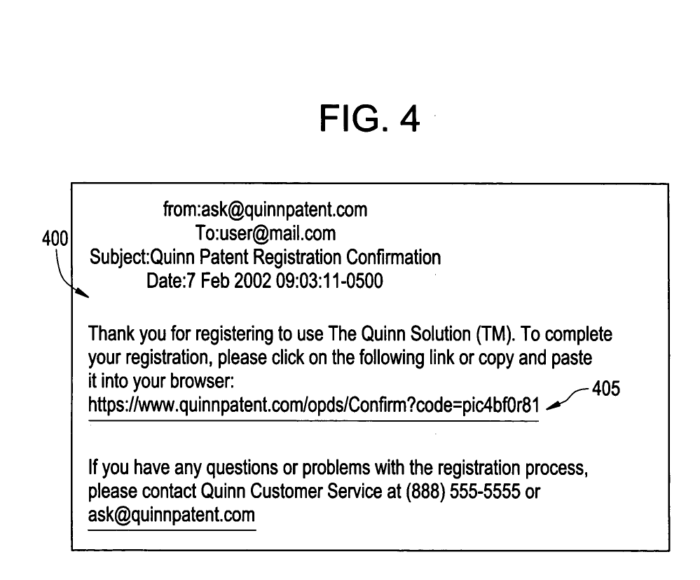

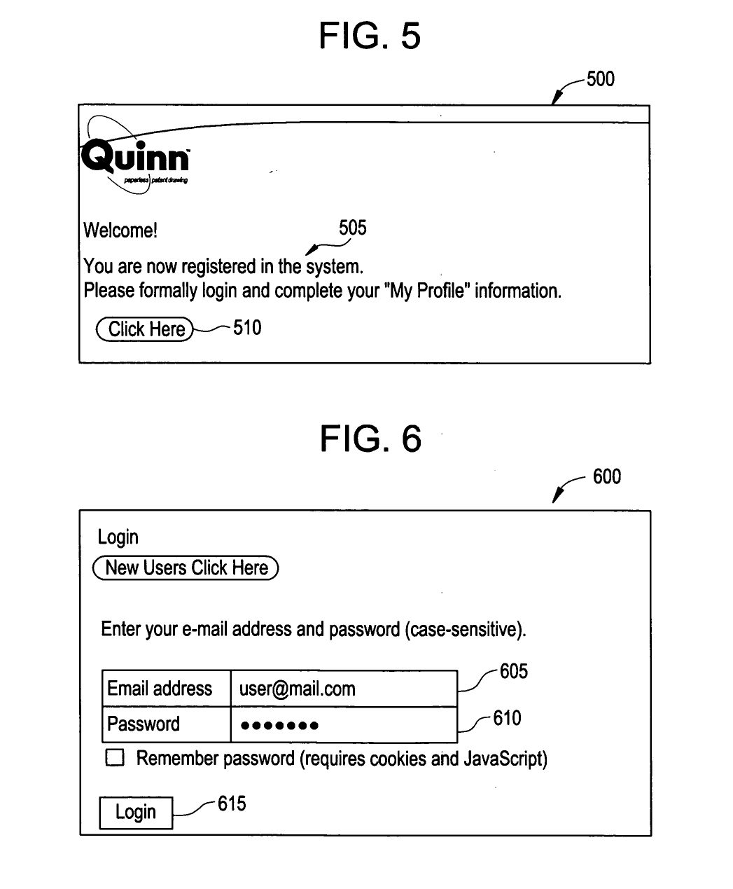

After the user registers, as illustrated in FIG. 4, a confirmation email is transmitted from one of the workstations (for example, a workstation serving as an email server) at the server computing site to the email address provided by the user during registration. In at least one embodiment, the email preferably includes a hypertext link 405 including a unique code. When the user clicks on the hypertext link 405 with a computer mouse, for example, a computer program module executes on the computer web server 122 at the server computing site 120, thereby presenting the user with a web page 500, as illustrated in FIG. 5. The web page 500 preferably includes a complete your profile information message 505 and an activation button 510 to allow the user to login to continue the registration process.

After being provided with the disclosure herein, those skilled in the relevant art will realize that automatic email confirmations may be transmitted upon the occurrence of a variety of types of actions or events in the present invention. For example, in at least one embodiment, automatic emails are preferably transmitted when an order has been received, after order completion, after drawing markups, after saving of drawing markups, and/or after revisions have been reposted. In an embodiment, an automatic email is sent to the customer, triggered by a date value entered into a “date completed field” of an electronic staff form. Thus, after the staff member completes the drawings for a customer, he simply enters the date of completion into the appropriate field. Afterwards, the system automatically sends an email to the customer notifying the customer that his or her drawings have been completed.

In at least one embodiment, the user must login to the system of the present invention. Thus, as illustrated in FIG. 6, login page 600, hosted by the computer web server 122, is preferably presented to a user at the client computing site 140. The login page 600 preferably includes an email address field 605 and an encrypted password field 610. The user preferably enters his or her email address into the email address field 605. The user preferably then enters his or her password in the encrypted password field 610. After entering the email address data and the password data, the user preferably logs in to the system by clicking the login button 615 to gain access to the system of the present invention.

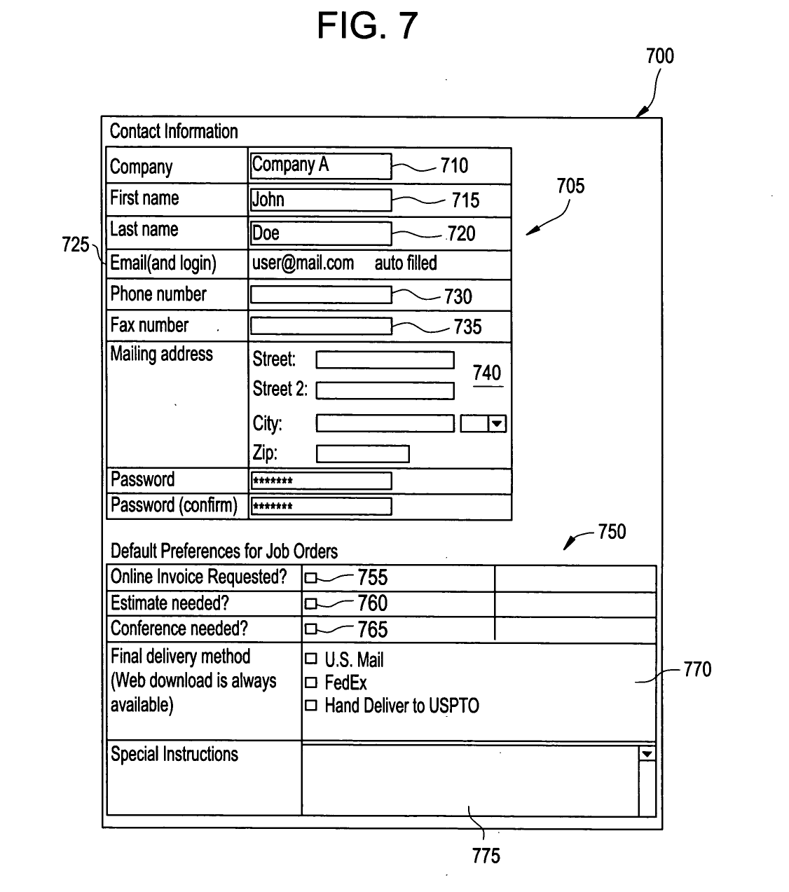

In at least one embodiment, the registration process continues after the user clicks the login button 615 in FIG. 6. For example, FIG. 7 illustrates an exemplary electronic profile data sheet 700. The exemplary electronic profile data sheet 700 preferably accepts additional information from the user at the client computing site. In at least one embodiment, the exemplary electronic profile data sheet 700 preferably includes a contact information section 705 and a default preferences for job orders section 750

The contact information section 705 (FIG. 7) preferably includes a company name field 710, a company representative first name field 715, a company representative last name field 720, an auto-filled email address field 725, a telephone number field 730, a facsimile number field 735, and a mailing address field 740. In at least one embodiment, the profile data sheet 700 further includes a “default preferences for job orders” section 750.

The default preferences for job orders section 750 preferably allows a user to configure certain options that are maintained for all of his or her drawing job orders unless the user specifically specifies a different value for an option during a specific drawing job order. For example, during configuration of the electronic profile sheet 700, the user may indicate that an estimate is not needed by not checking the box in the estimate needed field 760. Thus, every time thereafter that the user places an order, the estimate needed field 760 will indicate that an estimate is not needed. For a particular order that the user expects to be very expensive, however, the user may desire to have an estimate for the order. Therefore, the user may override the option value by clicking the box in the estimate needed field 760 to indicate that an estimate is to be provided for the drawing job.

In at least one embodiment, the default preferences for job orders section 750 preferably includes an “online invoice requested” field 755, an “estimate needed” field 760, a “conference needed” field 765, a “final delivery method” field 770, and a “special instructions” field 775. The conference needed field 765 preferably accepts an indication as to whether the user desires a virtual drawing conference to discuss the drawings provided by the draftsperson. This feature of the invention will be described in more detail herein below. In keeping with a particularly advantageous feature of the present invention, the online invoice requested field 755 preferably allows the user to receive invoices on-line. By providing this feature, when the user approves a drawing order (that is, when the user indicates he or she is satisfied with the draftsperson's work), an invoice is posted to the user's account. In at least one embodiment, an email is transmitted to the user including a link to allow them to view, print, or download their invoice. This invaluable feature enhances the user's ability to quickly view his or her billing charges and budget accordingly.

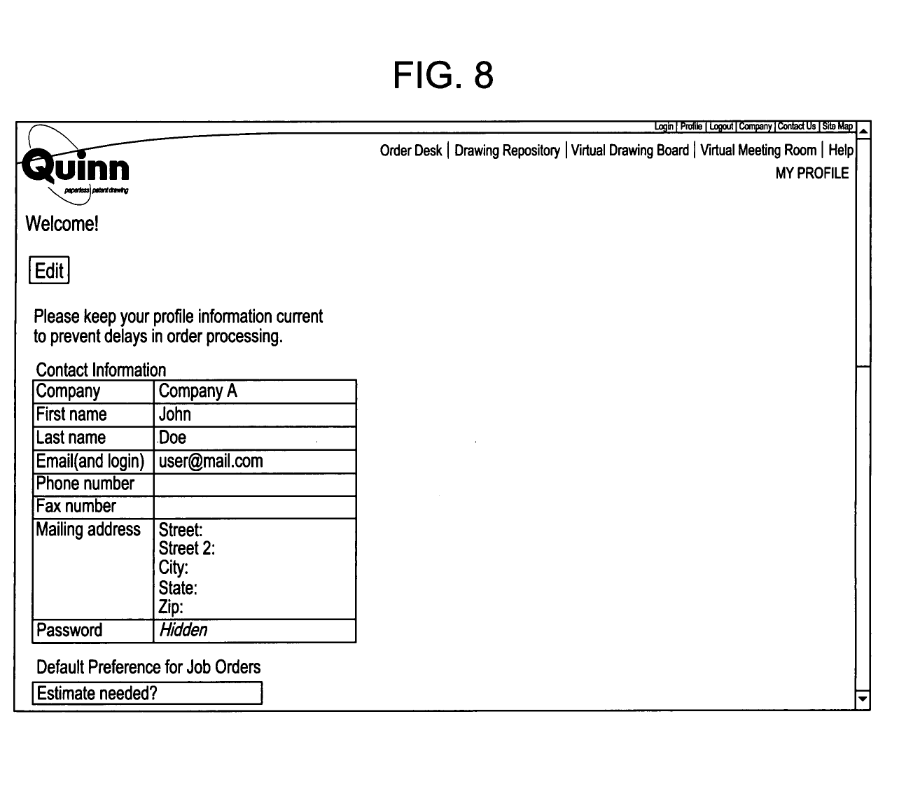

In at least one embodiment, the exemplary electronic profile data sheet 700 can be edited by the client, as shown in FIG. 8.

In keeping with a particularly advantageous aspect of the invention, an on-line virtual order desk is provided. This allows a client to quickly place an order for drawings with a draftsperson. For example, the client may order drawings on-line and avoid having to send a fax or call via telephone and possibly be placed on hold while the draftsperson accepts orders from another client.

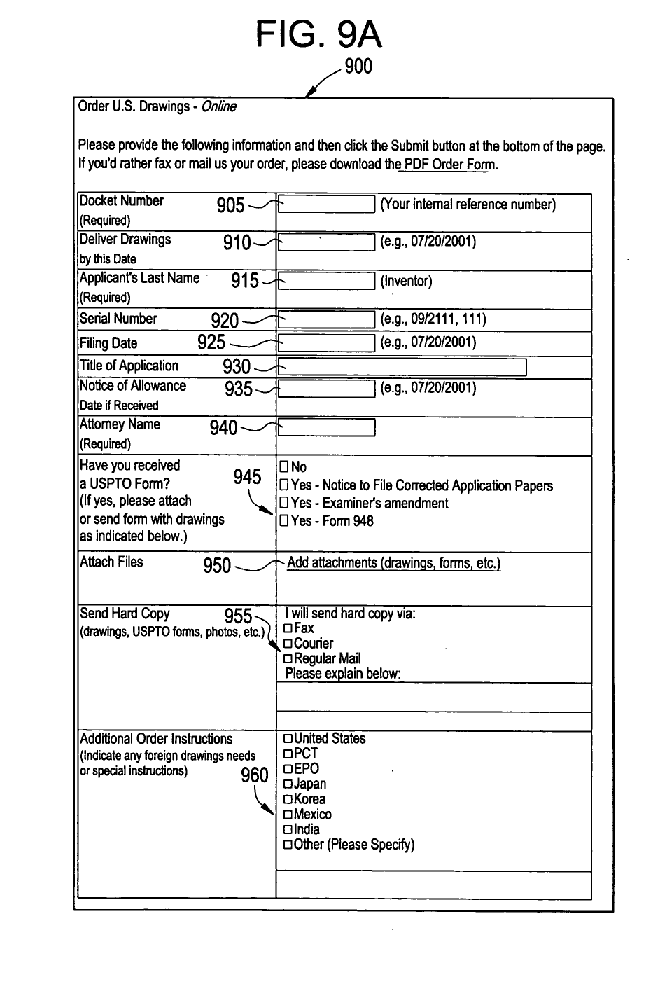

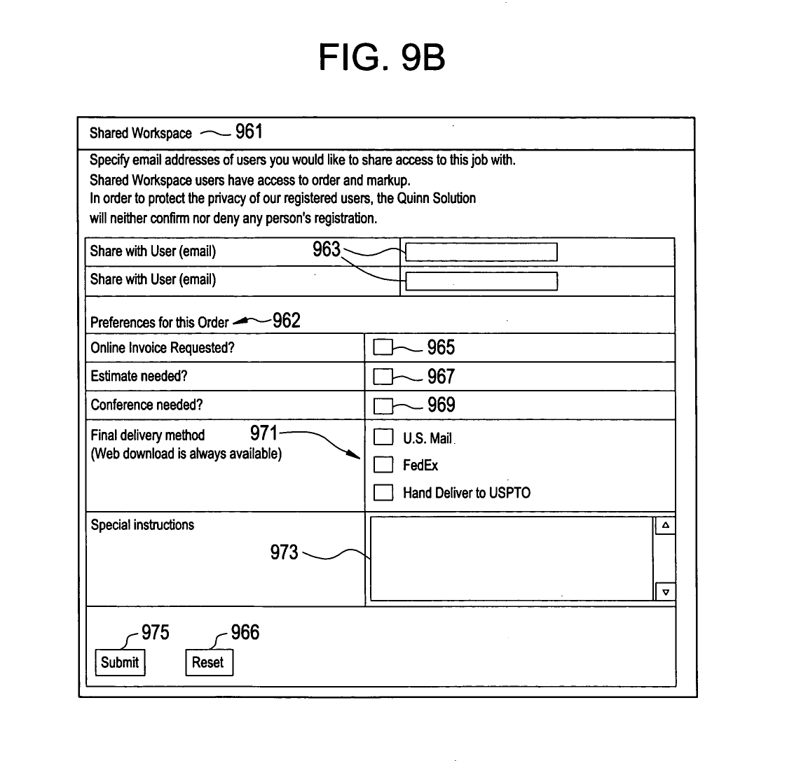

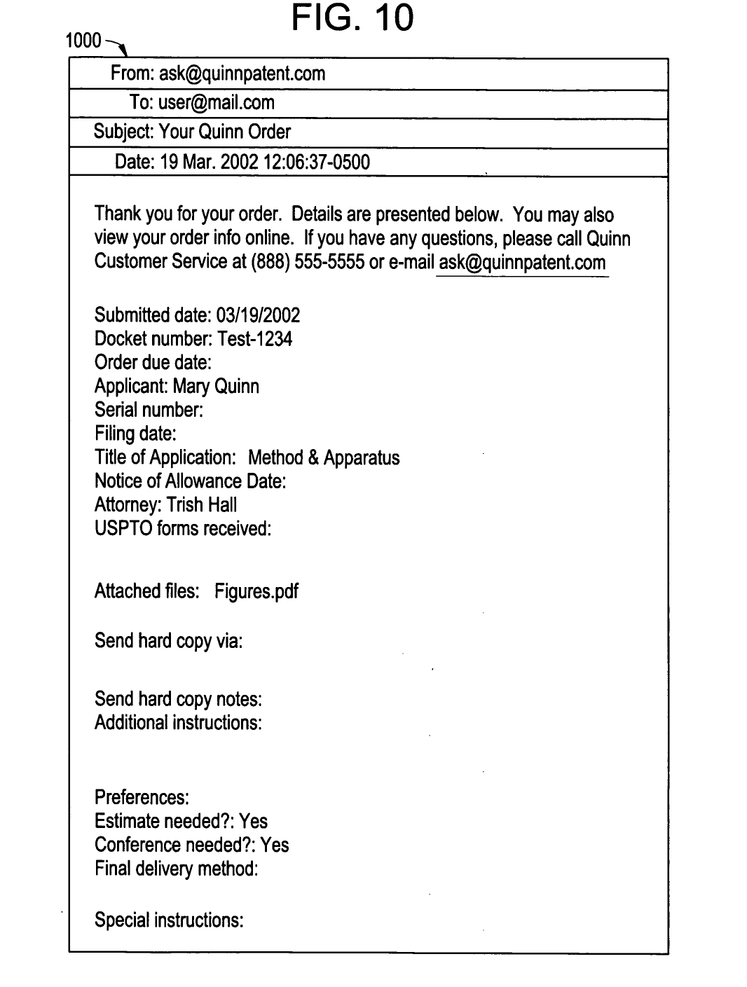

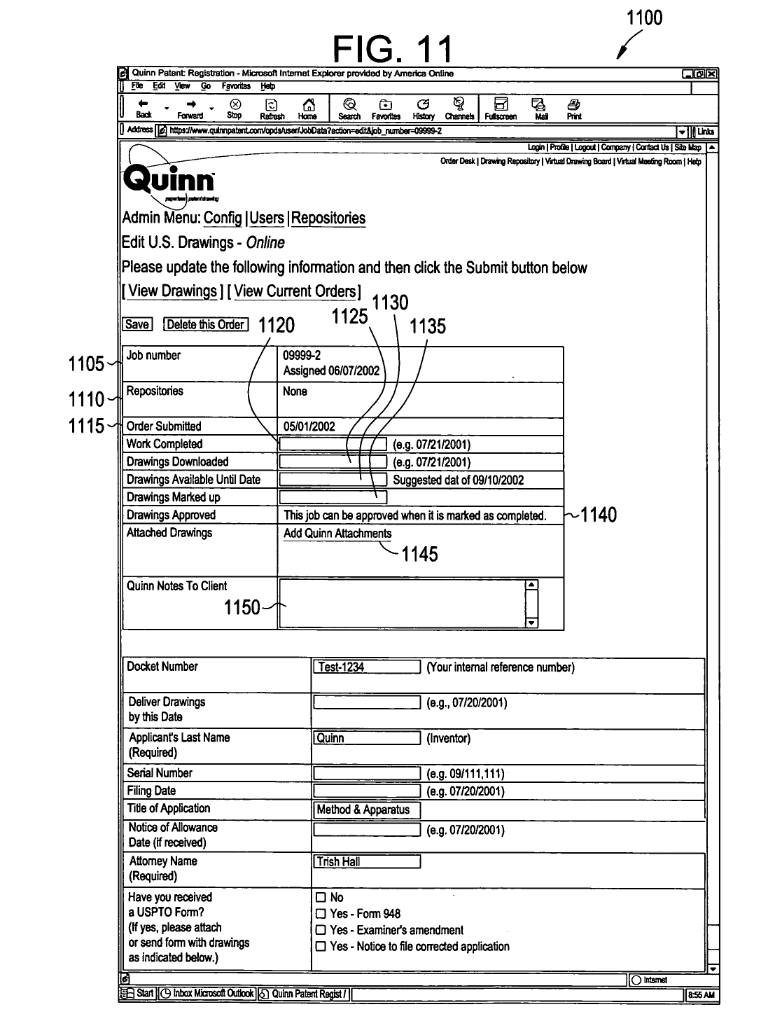

FIG. 9A illustrates an exemplary electronic order form 900 which the client preferably utilizes to order drawings on-line via the on-line virtual order desk of the invention. The electronic order form 900 preferably includes a “docket number” field 905, a “deliver drawings by this date” field 910, an “applicant's last name” field 915, a “patent application serial number” field 920, a “patent application filing date” field 925, “a title of patent application” field 930, a “notice of patent allowance field” 935, an “attorney name” field 940, and a “have you received a USPTO form” field 945. As these data fields are self explanatory, no further description will be provided herein. It should be noted that these fields are merely exemplary fields. After being presented with the disclosure herein, those of ordinary skill in the relevant art will realize that a variety of types of data fields may be utilized without departing from the spirit and scope of the present invention.

In addition to the identification type fields referenced above, the electronic order form 900 preferably includes an “attach files” field 950, a “send hard copy” field 955, and an “additional order instructions” field 960. In addition, FIG. 9B shows “a shared workspace” section 961 and a “preferences for this order section” 962.

The attach files field 950 preferably allows a user to attach electronic files including drawings, sketches, or images, for example. Such files preferably include a variety of types. For example, in at least one embodiment, such files include a “.TIFF” file type and a “.PDF” file type.

In some situations, for example, before obtaining drawings from a draftsperson, a user may already have rough electronic sketches, drawings, or images (for example, scanned files of graphical images) and wish to submit these in the attach files field 950 to assist the draftsperson in drafting more formal drawings.

In certain situations, a user may also have hard copies of drawings, charts, graphs, images, or sketches. In these instances, the system of the present invention allows the user to specify how the user would like to submit these copies to a draftsperson. Thus, the send hard copy field 955 allows the user to designate the desired method for sending hard copies of drawings, charts, images, or sketches, etc. The additional order instructions field 960 preferably allows the user to enter additional instructions (for example, instructions such as the jurisdiction for which the drawings are to be prepared).

As shown in FIG. 9B, in at least one embodiment, the shared workspace section 961 preferably allows a user to specify email addresses in email address field 963 or login names of other users (for example, other members on the user's team) with whom the user would like to share access to the particular order. In at least one embodiment, shared users have access to orders and the privileged capability to “markup” drawings in an order. For example, there may be a team of individuals at the client computing site 140 including team member A and team member B. Team member A may place a particular order using the electronic order form 900 and indicate that he wishes to share access to the order and drawings with team member B. In such a situation, team member A preferably enters the email address of team member B into the email address field 963 (Team member B must be registered). Thereafter, team member B may login to the system of the present invention and determine whether a drawing estimate, for example, was requested for the drawings by team member A. Team member B may also download the drawings and utilize the virtual drawing board to markup the drawings for the draftsperson. Team member B may also access the particular order placed to determine the status of the order, for example.

The preferences for this order section 962 preferably includes an “online invoice requested” field 965, an estimate needed field 967, a “virtual conference needed” field 969, a “final delivery method” field 971, and a “special instructions” field 973. It should be noted that the fields included in the preferences for this order section 962 preferably appear with selections already made in at least one embodiment of the present invention, as the values in these fields for the particular order represent the user's indication for the fields during the initial registration process previously described. As mentioned earlier, however, in at least one embodiment, the user is preferably allowed to alter the default selections in placing the particular order for a drawing job.

To submit the data in the electronic drawing form 900 to the computer web server at the server computing site 120, the user preferably clicks the “submit” button 975. Alternatively, the user may click the “reset” button 966 to clear all values from the data fields in the electronic order form 900.

After the user submits the information in the electronic order form 900, the draftsperson prepares the drawings digitally and posts the drawings on the website of the computer web server 122 at the server computing site 120.

In at least one embodiment, an order confirmation email 1000 notifying the user and/or any of the user's designees that an order has been successfully transmitted to the draftsman may be transmitted automatically from a workstation at the server computing site 120.

A draftsperson at the server computing site 120 preferably must now prepare the electronic drawings requested in the electronic order form 900 by the client at the client computing site 140. For example, the draftsperson may use a drawing software package such as AutoCAD®, manufactured by autodesk®, of San Rafael, Calif. or a graphics software package such as CorelDRAW®, manufactured by Corel Corporation of Ottawa, Canada. It should be noted that a variety of other types of drawing and graphics packages may be utilized in conjunction with the present invention.

After the draftsperson creates the electronic (digital) drawings, the drawings must be uploaded to the computer web server 122 at the server computing site 120 (FIG. 1). The electronic upload form 1100 is preferably utilized by a draftsperson to upload the digitally prepared drawings to the website. The upload is necessary to provide the requesting user with access to the drawings. As illustrated in the electronic upload form 1100, the identifying information provided by the user in the data fields for the electronic order form 900 are present in the electronic upload form 1100. The electronic upload form 1100, however, may also include additional fields. For example, the electronic upload form 1100 preferably includes a “job number” field 1105, a “repositories” field 1110, an “order submitted” field 1115, a “work completed” field 1120, a “drawing downloaded” field 1125, a “drawing available until date” field 1130, a “drawing marked up” field 1135, a “drawing approved” field 1140, an “attached drawings” field 1145, and a “notes to client” field 1150.

The job number field 1105 is preferably automatically generated by the system of the present invention in at least one embodiment. In at least one embodiment, the job number field 1105 is sequentially generated. The job number field 1105 preferably identifies the particular job order for easy access to the job order.

The repositories field 1110 preferably specifies a repository in which the drawings will be placed for storage and later retrieval by a user, as will be described further herein below.

The drawing marked up field 1135 preferably allows the draftsperson to enter a date on which the drawings were edited or “marked up” by the user. In at least one embodiment, the drawing marked up field 1135 is automatically populated. For example, after a user downloads a copy of the drawings prepared by the draftsperson, the user is preferably allowed to edit (for example, mark up) the drawings and submit the edited version of the drawings to the draftsperson to perform the changes. In at least one embodiment of the invention, the system notes the date the marked up version of the drawings were submitted and automatically populates the drawing marked up field 1135 with this date.

The drawing approved field 1140 preferably provides the draftsperson with an indication of whether the drawings have been approved.

The attached drawings field 1145 allows the draftsperson to upload the digitally prepared drawings to be reviewed by the requesting user. For example, in at least one embodiment, the drawings are preferably uploaded in “.pdf” format after being converted from “.dwg” or any other viable file type. In at least one embodiment, the present invention includes a file converter that converts the .pdf files to tiff files and converts the .tiff files to modified tiff files in at least one embodiment of the invention. In at least one embodiment, the .tiff files are preferably Group 4, 300 dpi files (size 8.5×11 inches). In at least one embodiment, the converter also preferably creates “zip” files to conserve storage space.

In addition to the two other user levels (that is, the staff user level (e.g., draftsperson) and the customer user level) described above, the present invention includes a system administration user level.

The system administration functions are available to a website or system administrator residing at the server computing site 120 of FIG. 1, for example. A system administrator may view a list of users of the system (for example, a list of customers), configure system settings, and configure repository settings). An administrator preferably may delete users of the system. In at least one embodiment, the system settings include options relating to file size limitations for uploading files and email confirmations to staff members. In at least one embodiment, an administrator may add logos and other types of graphical displays and customized text messages to the repository environment.

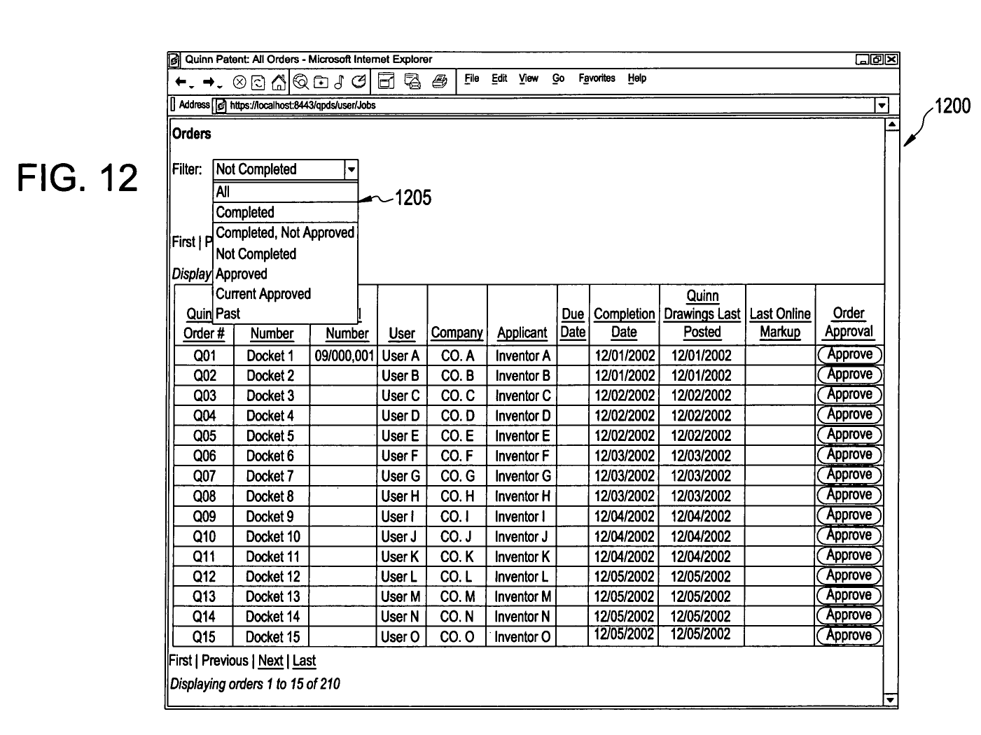

A variety of other types of administrator functions are provided. For instance, FIG. 12 illustrates an exemplary system administration sheet 1200 in which a staff member or system administrator may filter orders to determine the status of a group of orders. For example, if the system administrator would like to provide the draftsperson with a list of completed orders, he may select “completed” in dropdown list 1205, thereby providing a list of all completed drawing job orders.

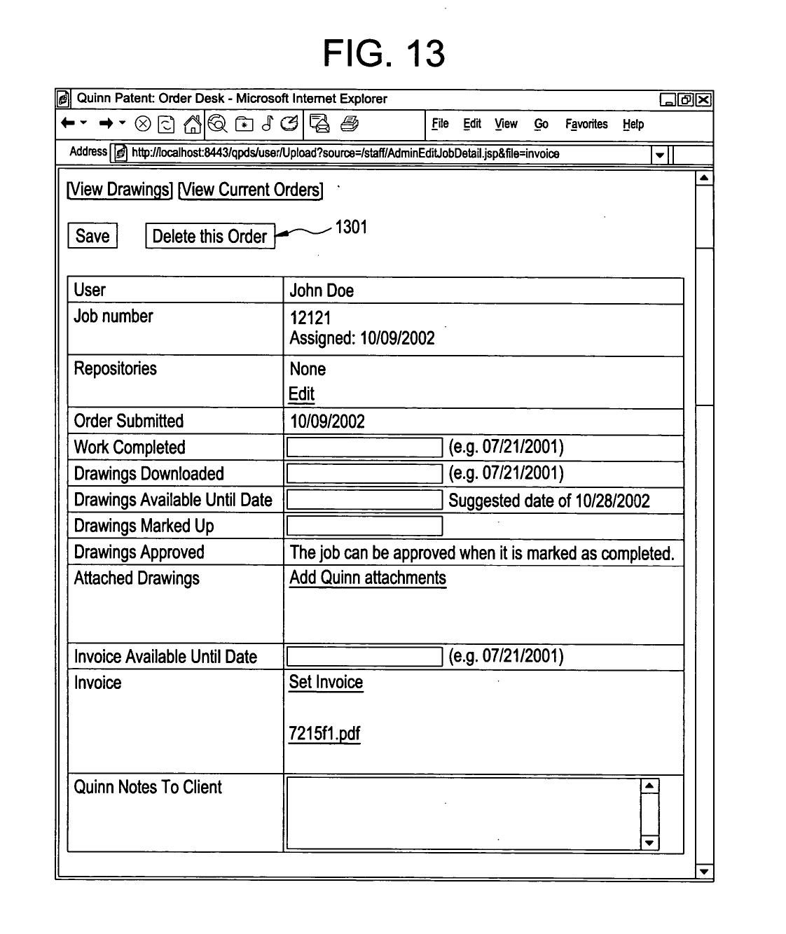

As illustrated in FIG. 13, the system administrator may also delete a particular order (for example, after learning that a client has requested cancellation of the order).

After the draftsperson uploads the prepared digital drawings, the user at the client computing site 140 preferably has access to an electronic drawing information chart 1400. The electronic drawing information chart 1400 (Virtual Drawing Board) preferably includes “drawing/order info” column 1405, “order #” column 1410, “docket number” column 1415, “patent application serial number” column 1420, “applicant” column 1425, “order submitted” column 1430, “drawings last posted” column 1431, “last online markup” column 1435, and “order approval” column 1440. Each row of the electronic drawing information chart 1400 preferably represents an order for drawings.

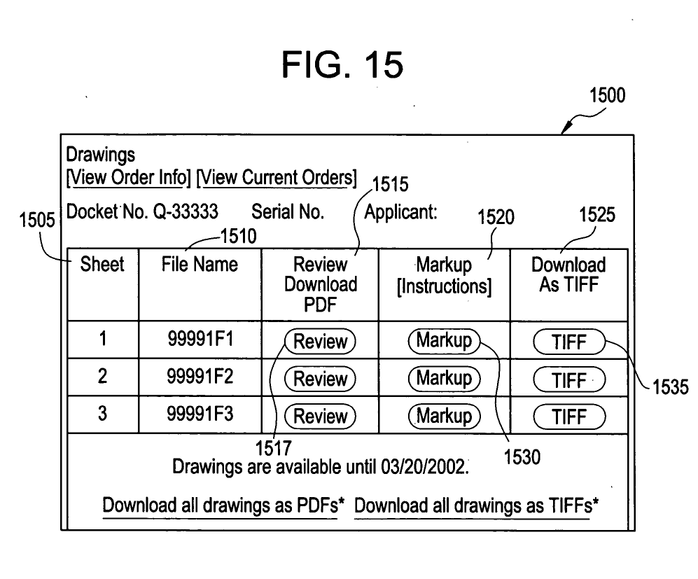

The drawing/order info column 1405 preferably includes a drawing activation button 1406 and an order information button 1407. The drawing activation button 1406 preferably allows the user to view the digital drawings prepared by the draftsperson. For example, upon clicking on the drawing activation button 1406, the user is preferably presented with a virtual drawing board access chart, as illustrated in FIG. 15, and as will be described in more detail in conjunction with FIG. 15. The order information button 1407 preferably allows the user to view the order information (for example, the order preferences, etc.) as it was submitted by the user.

The order # column 1410 preferably provides a system identification number for the particular drawing order. The symbols in the order # column 1410 (that is, “X” and the arrow symbols) preferably relate to file sharing. For example, in at least one embodiment, the symbols are color-coded. In such an embodiment, for example, a red “X” icon preferably indicates that the particular order is not shared, that is, the order is not accessible by other registered users. A green arrow icon preferably indicates that the order is shared by other registered users. A yellow arrow icon preferably indicates that someone has designated that the particular user has been designated to have access to at least one order and drawing of another. The docket number column 1415 preferably provides a user matter identification string. Columns 1430, 1431, 1435, and 1440 provide dates for their respective columns. Column 1425 provides identification information relating to the inventor or applicant.

Column 1440 preferably provides a date on which a particular order was approved. If, however, a customer has yet to indicate his approval of the order, he is preferably provided with an “approve” button 1445 for the particular order that is unapproved. If the user reviews the drawings associated with the particular order and determines that the drawings meet the approval of the user, then the user may depress the approve button 1445, thereby indicating his approval of the drawings in the particular order (the appropriate staff member will receive an email notification).

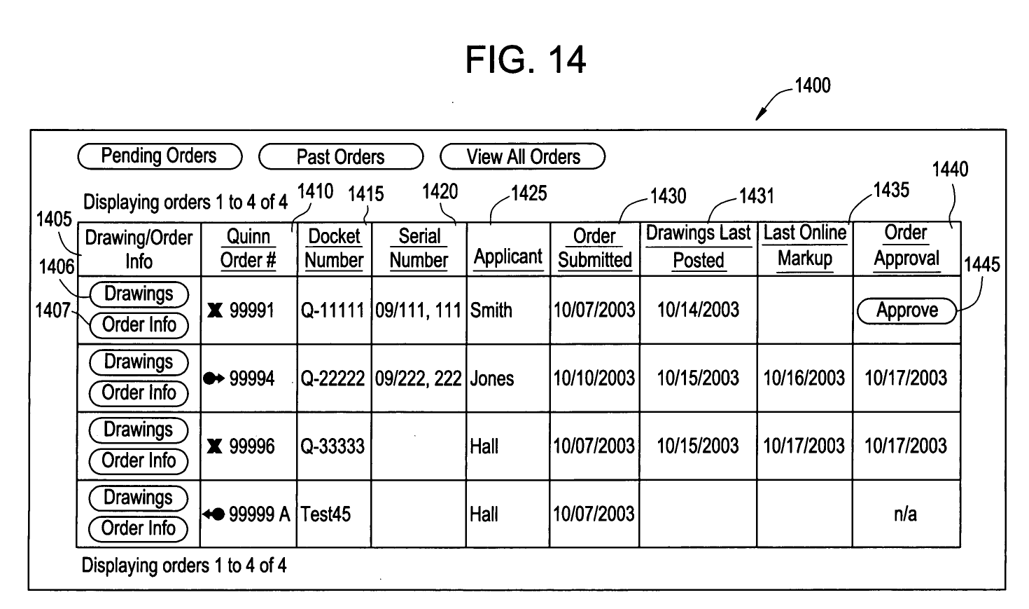

FIG. 15 illustrates an exemplary virtual drawing board access chart 1500. The virtual drawing board access chart 1500 is presented to a user of the client computing site 140, for example, after the user clicks the “drawings” activation button 1406 of the electronic drawing information chart 1400 illustrated in FIG. 14. The virtual drawing board access chart 1500 preferably includes a “sheet” column 1505, a “filename” column 1510, a “review/download PDF” column 1515, a “markup” column 1520, and a “download as TIFF” column 1525. Each row of the virtual drawing board access chart 1500 preferably represents a particular drawing in an order.

For example, the number “1” included underneath the sheet column 1505 preferably identifies the first drawing file in the particular order (for example, file 1 in order 99991, in FIG. 14).

Drawing sheet “1” preferably includes a file identifying name such as “99991F1,” as shown underneath the filename column 1510 in FIG. 15.

A “review” activation button 1517 is preferably included underneath the review/download PDF column 1515. The review activation button 1517 preferably allows the user to view on their monitor or download drawings created by the draftsperson to a workstation at the client computing site 140, for example. In at least one embodiment, such drawings are in the .PDF file format. After being presented with the disclosure herein, those skilled in the relevant art will realize that a variety of file formats may be utilized without departing from the spirit and scope of the present invention.

In at least one embodiment, the invention utilizes a three step process to generate the tiff files from an A4 sized .pdf file. In the first step of the process, a PostScript file is created from the .pdf file. Freeware software such as “pdftops” may be utilized to convert the .pdf file to a postscript file in at least one embodiment of the invention. In the second step, the PostScript file is scaled down and translated. Finally, in the third step, the processed PostScript file is converted to a .tiff file. Downloading of files occurs at a faster rate, as files to be downloaded are no longer copied to the web context. Instead, they are streamed from a directory where they reside. This also results in a more secure environment, as there is not an open window where drawing files are accessible to any logged in user of the system (to prevent guessing a job order number or drawing name, for example).

A “markup” activation button 1530 is preferably provided underneath the markup column 1520. The markup activation button 1530 preferably allows the user to view user instructions provided to the draftsperson regarding the particular drawing sheet. In at least one embodiment of the invention, the markup activation button 1530 preferably provides the user access to an editable version of the particular drawing. The user may “mark up” the drawing to indicate any desired changes the user would like the draftsperson to make to the drawings by clicking on the markup activation button 1530 with the user's computer mouse, for example. For instance, the user may place notes on the drawings or place an electronic “x” on a portion of the drawing to indicate to the draftsperson that the “crossed out” portion or section of the drawing should be deleted. Once the changes are saved by the user, the appropriate staff draftsman is notified via email. After being presented with the disclosure herein, those skilled in the relevant art will realize that a variety of other markup features may be incorporated into the present invention without departing from the scope and spirit of the invention.

A “TIFF” activation button 1535 is preferably provided underneath the download as TIFF column 1525. The TIFF activation button 1535 preferably allows the user to download a file in the TIFF format. Such a file format may be useful for a variety of purposes. For example, the United States Patent and Trademark Office has asserted that it accepts drawings in standard TIFF format. Thus, the system of the present invention allows the user to download the particular file in TIFF format to accommodate the USPTO requirement.

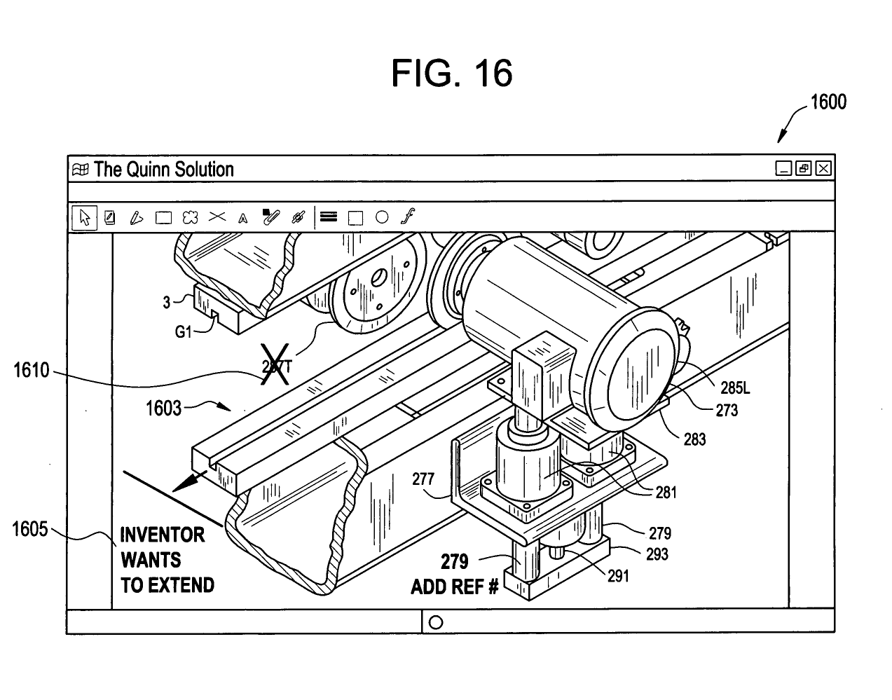

FIG. 16 illustrates a virtual drawing board 1600 in markup mode. The virtual drawing board 1600 is preferably presented to a user at the client computing site 140, for example, after clicking on the review activation button 1517 underneath the review/download PDF column 1515 illustrated in FIG. 15. As shown in FIG. 16, the user of the system of the present invention preferably utilizes the virtual drawing board 1600 to mark up a drawing 1603. For example, the user may add a message 1605 to the drawing 1603 for the draftsperson and/or place an “X” 1610 over a reference number in the particular drawing to indicate that the reference number should be removed. Thus, the virtual drawing board 1600 allows the user to submit changes and revisions to the drawings on-line, thereby resulting in rapid “turn-around” time of delivery of a finished product (that is, the user's desired drawings just as the user wanted the drawings to appear).

Although the virtual drawing board 1600 is extremely useful for allowing a user to convey the user's desires regarding a particular drawing and is also extremely convenient in allowing the user to markup the draftsperson's drawing without having to wait to contact the draftsperson, in some instances, there is no substitute for interacting with a draftsperson. For example, a user may not be pleased with the appearance of a drawing but may not know exactly how the drawing's appearance can be altered to allow its appearance to be more pleasing. In such a situation, direct interaction with a skilled draftsperson is often necessary. The virtual drawing board 1600 is an invaluable tool in that it allows the client to provide feedback to the draftsperson directly on the very drawing created by the draftsperson. The efficiency of the drafting process could be further enhanced, however, by allowing the draftsperson to receive real-time feedback from the client and by allowing the two parties to communicate in real-time or near real-time.

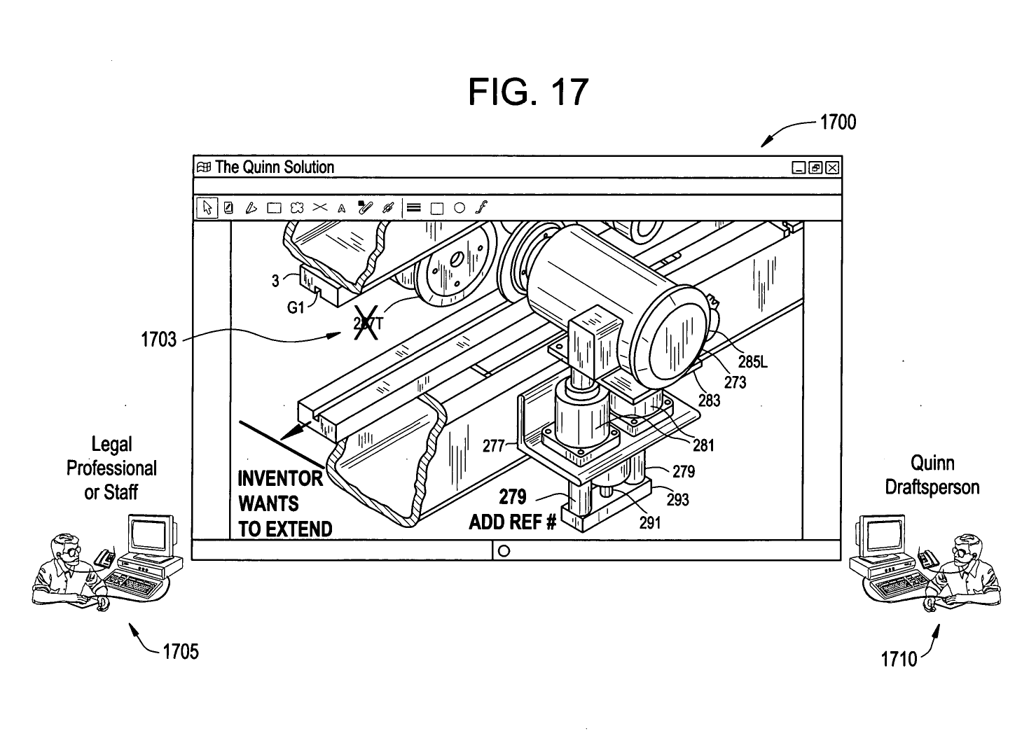

Thus, in keeping with a particularly advantageous aspect of the present invention, a virtual meeting room 1700 is provided. As illustrated in FIG. 17, a user at the client computing site 140 (for example, a customer of a draftsperson at the server computing site 120) may interact with a skilled draftsperson at the server computing site 120 via the virtual meeting room 1700. Both the user 1705 and the draftsperson 1710 have real-time or near real-time access to the drawing 1703 via their respective computing systems. For example, in at least one embodiment, the user 1705 may use a computer mouse attached to the client computing site 142 (in FIG. 1) to point or select, for example, a particular component on the drawing. Similarly, the draftsperson 1710 may use the computer mouse attached to a system connected to the server computing site 120 to point or select a particular component on the drawing 1703. Such interaction preferably allows the user 1705 and the draftsperson 1710 to experiment with altering (for example, rotating, altering size, changing dimensions) components of the drawing 1703. The user 1705 benefits from interacting with a skilled draftsperson, and the draftsperson 1710 benefits by having direct access to the user 1705 and being able to communicate with the user 1705 in near real-time or real-time to efficiently achieve the user's desires. In at least one embodiment, the virtual meeting room 1700 is enhanced via multi-media components.

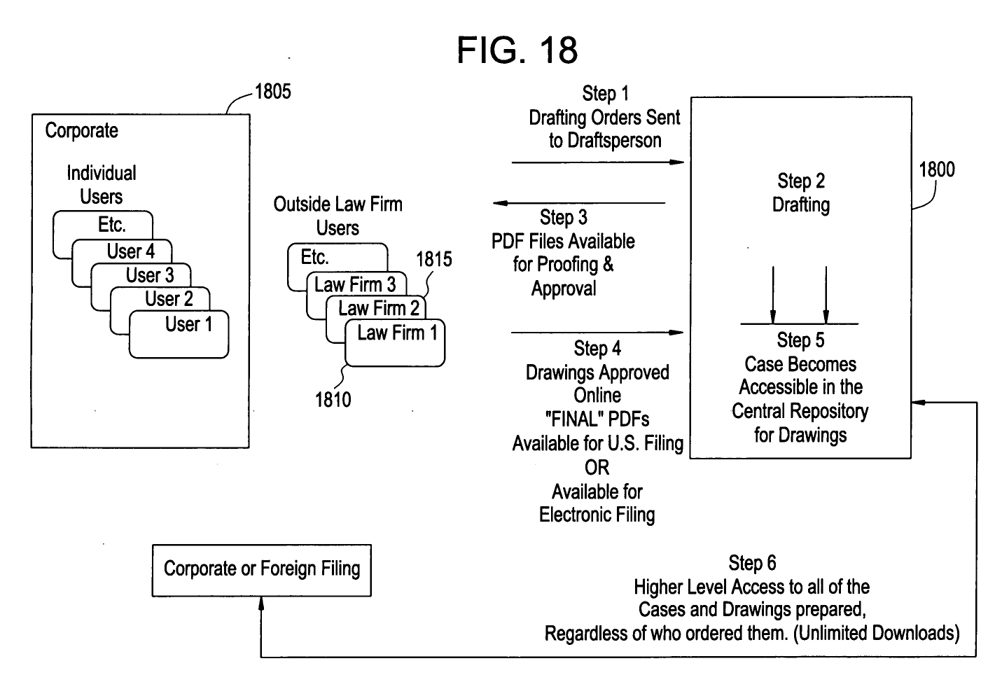

In keeping with another particularly advantageous aspect of the invention, a drawing file repository 1800 is provided, as illustrated in FIG. 18. The drawing file repository 1800 preferably allows a user to access drawing files created by the draftsperson for the user. Thus, rather than having to telephone the draftsperson, for example, the user may access the system of the present invention and review his or her drawings in the drawing file repository 1800 to obtain drawings for a related patent case, for example.

For instance, the drawing file repository 1800 preferably includes files from individual users at a corporation 1805 and files from a variety of different law firms (e.g., 1810 & 1815) working with the corporation 1805, for example. As all files are centrally stored in the drawing file repository 1800, drawing file misplacement and other mishaps are probably less likely to occur.

Continuing with the example offered above, the corporation 1805 (including individual Users 1-4) may have hired law firm 1810 as outside counsel for a child patent case to assist in drafting a patent application. In addition to drawings prepared by the individual User 1, for example, the law firm 1810 may have prepared drawings. The corporation 1805 may also have previously hired law firm 1815 to draft a parent patent application for the related child patent case that includes drawings useful in the parent patent case. Thus, the law firm 1815 may possess drawings (that is, the drawings from the parent patent case) that are useful in the current patent case (that is, the child patent case).

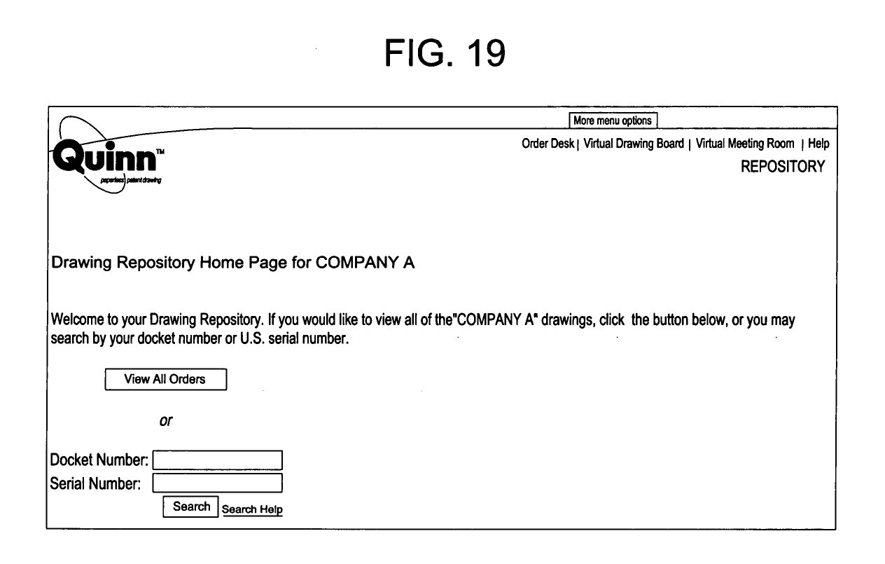

As a result of this scenario, the corporation 1805 should keep track of the drawings prepared by its individual users (e.g., Users 1-4) and the drawings prepared by the variety of law firms (e.g., 1810 and 1815). Such a task may be daunting to a corporation which files hundreds of patent applications per year. Thus, the drawing file repository 1800 of the present invention allows all users (for example, individuals from corporations, law firms, other teams) to store their drawing files in one central location (i.e., central drawing file repository 1800), thereby minimizing the possibility of losing or misplacing drawing files. Further, the drawing file repository 1800 allows a user to quickly search in one location for a particular drawing file, as indicated in FIG. 19. Operation of the drawing file repository 1800 will now be described.

In step 1, drafting orders are preferably sent to the draftsperson at the server computing site 120 (shown in FIG. 1). For example, a particular user from the corporation 1805 or a member of one of the law firms (e.g. 1810) may transmit a drawing order via email to the draftsperson.

In step 2, the draftsperson drafts drawings according to the order sent by the user. In step 3, the draftsperson allows the drawing files (e.g., PDF files) to be available to the user to allow the user to proof and approve the drawings. In step 4, the user approves the drawings, as described in the text accompanying FIG. 14. The drawings may now be utilized for an official traditional filing in the United States Patent and Trademark Office or for an electronic filing. After the user approves the drawings, in step 5, the draftsperson allows the files in the order to become accessible in the drawing file repository (that is, the central repository for drawings) 1800. It should be noted that in at least one embodiment, higher level access to all of the drawings and cases may be granted, as indicated in step 6. For example, in such an embodiment, a group of users may be members of a team. As a result, the various members of the team may require access to the drawings of a particular case or from multiple cases. Although the members may not have actually ordered the drawings, in the above-referenced embodiment, the members may be still granted access to all of the drawings. It should also be noted that the above referenced invention may also be utilized in a foreign environment (e.g., practice before the European Patent Office).

In at least one embodiment, the drawing file repository 1800 is a distinct account and requires a distinct username and password. For example, although a user may have the capability to store files in a particular file repository, he may not necessarily have the capability to login to review all files stored in the repository, as the repository has a distinct username or identifier and password. In keeping with a particularly advantageous aspect of the invention, the drawing file repository 1800 is preferably tiered or layered. For example, a corporation may have a file repository for each division. In at least one embodiment, file repositories may be built by assigning users or orders to a file repository. For example, a new file repository may be created. After creation, a system administrator may specify that the file repository include users or orders from three other selected file repositories, for example.

It should be noted that although the present invention has been presented in the context of being utilized with the patent system, the present invention may also be utilized with other systems. For example, the present invention may be employed in any industry where drawings are utilized, for example, the fashion, construction, architecture, or medicine industry, etc. It should also be noted that although the present invention has been presented in the context of being utilized by a draftsperson at a server computing site and the draftsperson's customer at a client computing site, the invention may also be employed by a plurality of users at the same computing site.

Those skilled in the art will appreciate that various adaptations and modifications of the above-described embodiments can be configured without departing from the scope and spirit of the present invention. Therefore, it is to be understood that, within the scope of the appended claims, the invention may be practiced and constructed other than as specifically described herein.

1. A paperless method for facilitating collaboration between users regarding graphical illustrations or images over a computer network, comprising:
providing at least one server computer in communication with the computer network;
receiving an order at the server computer via the computer network for preparation of at least one drawing; and
posting said at least one drawing on a webpage hosted by the at least one server computer to allow for possible markups of the at least one drawing.

2. The method of claim 1, further comprising providing an on-line virtual conference room in which a plurality of users have simultaneous interactive access to the at least one drawing.

3. The method of claim 1, wherein said receiving step includes receiving an electronic file attachment of a drawing or photograph.

4. The method of claim 1, further comprising, before said receiving step, providing a new user registration process.

5. The method of claim 4, further comprising, collecting profile information from a user.

6. The method of claim 1, wherein said receiving step includes receiving at least one of a patent application serial number, a patent application filing date, an indication of whether a USPTO form has been received, and an indication of a method of how a user will send a physical copy of drawings or photographs associated with the order.

7. The method of claim 1, wherein said receiving step includes receiving an indication of whether access to the order is to be shared by a group of users.

8. The method of claim 1, wherein said receiving step includes receiving an indication of whether on-line invoicing is to be provided for the order.

9. The method of claim 1, wherein said receiving step includes receiving an indication of whether a virtual conference is to be provided for the order.

10. The method of claim 1, further comprising, after said receiving step, transmitting a confirmation message to an originator of the order to confirm receipt of the order.

11. The method of claim 1, wherein said posting step includes the step of allowing a user to approve drawings of an order on-line.

12. The method of claim 1, wherein said posting step includes allowing a user to provide markup instructions.

13. The method of claim 1, wherein said posting step includes allowing a user to download a .PDF file type.

14. The method of claim 1, wherein said posting step includes allowing a user to download a TIFF file type.

15. The method of claim 2, wherein said providing step includes providing multi-media communication in real-time.

16. The method of claim 1, wherein said posting step includes employing a process to generate tiff files from an A-4 sized .pdf file.

17. The method of claim 16, wherein said employing step includes:
creating a postscript file from the .pdf file;
scaling the postscript file;
translating an image in the postscript file; and
converting the postscript file to the tiff file.

18. The method of claim 1, further comprising providing a file repository for storing drawing files.

19. The method of claim 1, further comprising providing a multi-layered file repository.

20. The method of claim 18, further comprising assigning users or orders to the file repository.

21. An automated system for facilitating collaboration between users regarding graphical illustrations or images over a computer network, comprising:
a first module for receiving an order for preparation of at least one drawing;
a second module for allowing review, revision, and approval of said at least one drawing;
a third module for allowing interactive communications regarding said at least one drawing to occur, said communications occurring between at least a first individual and a second individual; and
at least one server computer accessible via the computer network by at least one client computer, said at least one server computer for executing said first, second, and third modules to allow a user of said client computer to interact with the system.

22. The system of claim 21, wherein said first module includes computer readable instructions for receiving an electronic file attachment of a drawing or photograph.

23. The system of claim 21, further comprising, a fourth module including computer readable instructions for providing a new user registration process.

24. The system of claim 21, wherein said fourth module includes computer readable instructions for transmitting a registration confirmation message to a user after the registration process.

25. The system of claim 21 further comprising, a fifth module including computer readable instructions for collecting profile information from a user.

26. The system of claim 21, wherein said fifth module includes computer readable instructions for collecting at least one of a company name, a first name, a last name, an email address, a phone number, a mailing address, and a group of default preferences for orders placed by a user.

27. The system of claim 21, wherein said first module includes computer readable instructions for receiving at least one of a patent application serial number, a patent application filing date, an indication of whether a USPTO form has been received, and an indication of a method of how a user will send a physical copy of drawings or photographs associated with the order.

28. The system of claim 21, wherein said first module includes computer readable instructions for receiving an indication of whether access to the order is to be shared by a group of users.

29. The system of claim 21, wherein said first module includes computer readable instructions for receiving an indication of whether on-line invoicing is to be provided for the order.

30. The system of claim 21, wherein said first module includes computer readable instructions for receiving an indication of whether a virtual conference is to be provided for the order.

31. The system of claim 21, wherein said first module includes computer readable instructions for transmitting a confirmation message to an originator of the order to confirm receipt of the order.

32. The system of claim 21, wherein said first module includes computer readable instructions for allowing a user to approve drawings of an order on-line.

33. The system of claim 21, wherein said second module includes computer readable instructions for allowing a user to provide markup instructions.

34. The system of claim 21, further comprising a fourth module for allowing a user to download a .PDF file type.

35. The system of claim 21, further comprising a fourth module for allowing a user to download a TIFF file type.

36. The system of claim 21, wherein said fourth module includes computer readable instructions for providing multi-media communication in real time.

37. The system of claim 21, further comprising a third module for providing a file repository for storing electronic files.

38. The system of claim 37, wherein said file repository is layered.

39. The system of claim 37, wherein orders or users are assigned to said file repository.
